(19) United States
(12) Patent Application Publication
(10) Pub. No.: US 2018/0130064 A1
(43) Pub. Date: May 10, 2018

(54) METHOD AND DEVICE FOR DISPENSING PRESCRIBED PRODUCTS

(71) Applicant: Gilles Bos, Petit-Lancy (CH)

(72) Inventor: Gilles Bos, Petit-Lancy (CH)

(21) Appl. No.: 15/576,297

(22) PCT Filed: May 26, 2016
(86) PCT No.: PCT/IB16/53088

§ 371 Date: Nov. 22, 2017

(30) Foreign Application Priority Data
May 26, 2015 (FR) 15 54693

(51) Int. Cl. G06Q 20/42; G06Q 20/12; G06Q 20/20; G06Q 20/32; G06Q 20/38; G06Q 30/02; G06Q 30/06

(52) U.S. Cl. CPC G06Q 20/42; G06Q 20/12; G06Q 20/20; G06Q 20/322; G06Q 30/0637; G06Q 20/3821; G06Q 20/385; G06Q 30/02; G06Q 20/3274

(57) ABSTRACT

A commercial site generates at least one identification badge in which a customer identifier and, if necessary, a customer password are stored. The commercial site assigns an account to the Identification badge. A diagnosis and advice site receives, from the commercial site, a supply of Identification badges and assigns one of the Identification badges to a customer. The diagnosis and advice site creates, in the commercial site, a shopping cart in the account assigned to the Identification badge entrusted to the customer. The customer is connected to the commercial site via a customer terminal by presenting the customer identifier and customer password borne by the identification badge, and the customer completes his or her account with his or her personal information. The commercial site allows only products listed in the shopping cart created by the diagnosis and advice site to be delivered to the customer.

### TECHNICAL FIELD OF THE INVENTION

The present invention relates to devices that make it possible to control the distribution of products from a commercial site that have been ordered via the Internet.

The growth of the Internet and of secure connection means has given everybody a wealth of opportunities to create a personal account on commercial sites so as to have the products they want delivered quickly.

Each time a user wishes to create an account on one or other of these sites, the process is more or less the same: the Internet service provider (the ‘provider’) prompts the creation of an account by way of a ‘login’ (identifier or access code) and a password being chosen.

Internet selling does not, in principle, pose any difficulties for consumer products, except with regard to the security necessary for financial transactions, this being regulated by particular procedures.

However, Internet selling seems less suitable when the products on the commercial site require advice in order to prevent incorrect use of the products or a lack of knowledge or judgment on the part of the customer with regard to the large amount of products on offer or with regard to the technical complexity of the products.

Such is the case, for example, for pharmaceutical products and high-end products in the field of cosmetic care and anti-ageing treatments that are intended for treatment programs in which the choice of products is essential for achieving the desired effect.

There is thus a need to advise the customer and then to ensure that the customer has understood the advice and will observe the prescriptions when he orders the products on a commercial site via an Internet connection, without being overwhelmed by vast amounts of information and offers available via the Internet.

### DISCLOSURE OF THE INVENTION

One problem proposed by the present invention is that of guaranteeing the customer both ease of access to his personal account on a commercial site in order to make the most of the facilities resulting from using the Internet to place orders, and effective advice enabling him to choose products suited to the results that he wishes to achieve therefrom.

Another problem proposed by the present invention is that of ensuring that the customer follows the effective advice that has been given to him, and does not deviate therefrom by ordering products that are entirely different from those that have been recommended to him.

Another problem proposed by the present invention is that of reducing the operations that the customer has to perform to place the order for the products that have been recommended to him.

Another problem proposed by the present invention is that of reducing the operations that the consultant has to perform when he prescribes products for a new customer.

To achieve these and other goals, the invention proposes, according to a first aspect, a device for controlling the distribution of products, comprising:
a) a commercial site having:
   a database,
   preformatted personal customer accounts, each assigned to a corresponding portable identification medium containing a customer identifier,
   a series of consultant identifiers and a corresponding series of consultant passwords,
   means for accessing the database via the Internet,
   Internet access control means that ensure, when a customer requests access, that a customer identifier and a customer password are checked,
b) at least one customer terminal, able to communicate with the commercial site via a secure Internet connection for payment operations,
c) at least one diagnosis and advice site, having an input-output interface able to be accessed by a consultant, having a connection means for communicating with the commercial site via an Internet connection, having its own consultant identifier, and having its own consultant password,
d) said Internet access control means furthermore ensuring, when a consultant requests access, that a consultant identifier and a consultant password are checked.

With such a device, when the customer wishes to order products on the commercial site, he first of all consults the consultant of the diagnosis and advice site, who delivers to said customer a portable identification medium containing a customer identifier, and who communicates a customer password to said customer. At the same time, the consultant draws up a list of products that may be suitable for the customer, depending on the results he needs and depending on the consultant's knowledge on how to achieve said results, and said consultant places this list of products in the cart that is assigned, on the commercial site, to the portable identification medium that said consultant has delivered to the customer. In this operation, the Internet access control means of the commercial site check the consultant identifier and the consultant password in order to authorize the addition of the list of products to the cart assigned to the portable identification medium delivered to the customer.

As an alternative, the consultant of the diagnosis and advice site may have specific identification media associated with standard carts, that is to say containing a previously drawn-up list of products to be prescribed. In this way, the consultant does not need to add the list of products to be prescribed, which is already present, to the customer's cart himself. This alternative is beneficial in the case where the list of products to be prescribed is often identical.

Next, when the customer wishes to place an order for products with the commercial site, he identifies himself using his customer identifier and a customer password and, after checking the customer identifier and the customer password, the commercial site authorizes him to place the order for all or some of the products contained in the cart assigned to his portable identification medium.

In this way, the customer is forced to follow the advice that has been given to him by the consultant, and he does not have the option of ordering products that would deviate from the list drawn up by the consultant. He is able, on the other hand, to freely add additional products that do not require selection by or assistance from a consultant.

At the same time, the customer only needs to check all or some of the products on the list drawn up by the consultant, such that the operations that he has to perform to place the order are considerably reduced.

For his part, the consultant only needs to communicate, to the commercial site, the identity of the portable identification medium that he has handed over to the customer, and the list of products in the cart that he recommends. It is the customer, when he first connects to the commercial site, who is himself able to add personal data relating to him, insofar as said data have not already been recorded at the time of a previous connection by the customer. The operations that the consultant has to perform are thus also reduced.

It is also possible to reduce the number of operations that the customer has to execute when he connects to the commercial site, by providing that the customer terminal comprises:
reading means for reading the data carried by a portable identification medium when the latter is presented by a customer, and for extracting the customer identifier therefrom,
entry means, by way of which the customer is able to enter his customer password,
communication means for communicating to the commercial site, via the Internet, the customer identifier and the customer password in order to gain access for the user to the preformatted personal customer account assigned to the portable identification medium presented by the customer.

In this way, the customer does not need to worry about remembering his customer identifier, and he does not need to worry about entering his data into his customer terminal in order to begin his access to the commercial site.

The security of the transactions is able to be increased by providing that the customer terminal furthermore comprises local control means for compelling the customer to enter his customer password when he wishes to gain access to his personal customer account on the commercial site, and for checking the customer password entered by the customer.

The customer is thus able to be assured that another user is not able to place an order relating to all or some of said customer's cart without his knowledge.

In practice, it may advantageously be provided that the commercial site comprises means for generating and managing personal customer accounts and for associating at least one identification medium with each personal customer account.

In this way, it is the commercial site that generates the identification media and that communicates them to the diagnosis and advice site, the latter not having to perform any operation on the identification media, which it simply delivers to the customers.

For its part, the diagnosis and advice site has a (physical or non-physical) supply of identification media, which its consultant is freely able to deliver to customers, and has rights, associated with its consultant identifier and its consultant password, to generate, on the commercial site, a cart in the account associated with the identification medium that the consultant delivers to a customer.

According to a first variant, the diagnosis and advice site has rights, associated with its consultant identifier and its consultant password, to assign, to the identification medium, a customer password, in order to communicate it to the commercial site, which then associates it with the corresponding customer identifier, and the consultant communicates it to the customer.

According to a second variant, a customer password is assigned beforehand, by the commercial site, to each customer identifier, and the diagnosis and advice site has rights, associated with its consultant identifier and its consultant password, to extract, from the commercial site, the customer password that the consultant is able to communicate to the customer. This second variant has the advantage of reducing the operations that the consultant of the diagnosis and advice site has to perform. Specifically, when the customer visits the consultant running the diagnosis and advice site, the consultant and the customer do not have to agree upon and enter the customer password.

In the two variants, the customer, provided with his identification medium, has rights, associated with his customer identifier and his customer password, to order, on the commercial site, the products present in the cart generated by the consultant in the personal customer account associated with his identification medium.

Preferably, in the identification medium, the customer identifier is encoded in an image able to be read optically, for example encoded in the form of a QR code.

The risk of a malicious third party placing an order without the knowledge of the customer is thus reduced.

According to one advantageous possibility, it is furthermore possible to provide that the customer password is also encoded in said image.

In this way, it is also possible to envision that the customer terminal is provided with local control means and is itself able to perform a check on the customer password entered by the customer, by comparison with the customer password encoded in said image, in order to prevent Internet communication in the case of an error in the customer password entered by the customer.

In practice, the image may be produced on a physical medium such as paper or a laminated card, or it may be produced on a non-physical medium such as a digital recording.

According to a second aspect, the invention proposes a method for controlling the distribution of products from a commercial site, wherein:
the commercial site generates at least one identification medium in which a customer identifier is stored,
the commercial site assigns a personal customer account to the identification medium,
a diagnosis and advice site, run by a consultant, receives a supply of identification media from the commercial site, and the consultant of said diagnosis and advice site assigns, to each customer who requests one, one of the identification media from said supply of identification media,
the consultant of the diagnosis and advice site creates, on the commercial site, a cart in the personal customer account assigned to the identification medium handed over to the customer, into which cart said consultant places the list of products that may be suitable for the customer,
the consultant of the diagnosis and advice site extracts, from the commercial site, or assigns and communicates, to the commercial site, a customer password, and then communicates said customer password to the customer,
the customer connects to the commercial site via a customer terminal, by presenting his identification medium containing the customer identifier, and by entering his customer password, and he completes his personal customer account with his personal information, insofar as said information has not yet been recorded in his associated personal customer account,
the commercial site authorizes the delivery, to the customer, of the products listed in the cart created by the consultant of the diagnosis and advice site.

In such a method, it may furthermore advantageously be provided that:
in the identification medium, the customer identifier is encoded in the form of an image,
in the customer terminal, the customer presents his identification medium, the customer terminal reads the image from the identification medium in order to extract the customer identifier therefrom, and the customer enters his customer password,
the customer terminal sends, via the Internet, the customer identifier and the customer password to the commercial site, which performs a check in order to authorize the customer to communicate in order to place an order by way of the customer terminal.

The image containing the customer identifier may advantageously be an image of QR code type.

The customer password may furthermore be encoded in said image.

### BRIEF DESCRIPTION OF THE DRAWINGS

Other aims, features and advantages of the present invention will emerge from the following description of particular embodiments, given with reference to the attached figures, in which:

FIG. 1 is a schematic depiction of a device according to the invention that makes it possible to control the ordering of products on a commercial site via the Internet;

FIG. 2 is a schematic depiction of the encoding of the customer identifier and possibly of the customer password in the form of an image in order to create an identification medium according to the invention;

FIG. 3 illustrates a computer program routine for issuing the identification media;

FIG. 4 illustrates a routine for checking and connecting a customer terminal to the website; and

FIG. 5 illustrates a routine implemented by a diagnosis and advice site for drawing up the prescription of products for the customer's benefit.

### DESCRIPTION OF PREFERRED EMBODIMENTS

In all of the embodiments illustrated in the figures, the device according to the invention is intended to enable managed access to a commercial site 1 via the use of a portable identification medium 4 made available to a customer.

The identification medium 4 contains a customer identifier 8. As illustrated in the example of FIG. 2, the customer identifier 8 comprises at least 6 characters, said 6 characters comprising at least one letter and at least one number. The identification medium 4 possibly furthermore contains a customer password 9, comprising at least 4 numbers.

According to one advantageous implementation that facilitates communications via the Internet and the processing of said communications upon reception, the customer identifier 8 may be structured in the form of a web address or URL (Uniform Resource Locator) address, for example: http://(domain name of the commercial site)/(code of the identification medium)=(user code).

One example of a user code structure may be: FRA2-1AZ3, that is to say a two-digit country code, such as FR, followed by a first two-digit identifier, such as a letter from A to Z and a number between 0 and 9, and a second four-digit identifier, such as a number between 0 and 9, two letters from A to Z and a number between 0 and 9.

In the identification medium 4, the customer identifier 8 and possibly the customer password 9 are encoded in the form of an image 20. In the example illustrated in FIG. 2, the image 20 is a QR code.

More generally, the device according to the invention, in order to enable managed access to the commercial site 1, comprises the commercial site 1 itself, which is provided with a database 2, Internet access means 5 for enabling access to its database 2 via the Internet 6, and control means 7 for controlling access to its database 2 via the Internet 6. The control means 7 make it possible in particular, when a customer requests access, to check the customer identifier 8 and the customer password 9.

The control means 7 may for example be formed using the software marketed under the brand Magento, available on the website magento.com, and including development tools. The checking is one of the core functions of this Magento software.

Communication between the customers and the commercial site 1 is carried out via the Internet 6, by means of terminals such as the customer terminal 10, the latter possibly being a fixed terminal, a computer or a mobile telephone of smartphone type.

In the embodiment illustrated, the customer terminal 10 is a reading and transmission computer terminal, including reading means 16 for reading the image 20 contained in the identification medium 4 that the customer has, and including an input-output interface 19 that the customer actuates in order to enter his customer password 9.

For example, the reading means 16 comprise a camera able to digitize the image 20 carried on an identification medium 4 in the form of a sheet of paper on which the image 20 has been printed.

The reading and transmission computer terminal 10 furthermore comprises decryption means 21 for decrypting said image 20 and extracting the customer identifier 8 therefrom.

According to the invention, the action performed by the decryption means 21 for decrypting the image 20 and extracting the customer identifier 8 therefrom consists in converting the digital 2D information contained in the image 20 into digital information in text form, forming the customer identifier 8.

One example consists in providing a customer terminal 10 in the form of a mobile telephone of smartphone type on which an application for reading image codes, such as QR codes, has been downloaded, for example the application known under the brand name ‘neoreader’, commonly available in application libraries on the operating systems known under the brand names IOS and Android.

The reading and transmission computer terminal 10 also comprises communication means 11 for communicating, to the commercial site 1, via the Internet 6 and securely, the customer identifier 8 and the customer password 9 in order to gain access for the customer to a personal account 3 that he possesses on the commercial site 1. The secure transmission of the customer identifier 8 and of the customer password 9 is advantageously carried out in encrypted form via the Internet 6.

In practice, for the secure transmissions, it is advantageously possible to use the https (hypertext transport protocol secure) protocol.

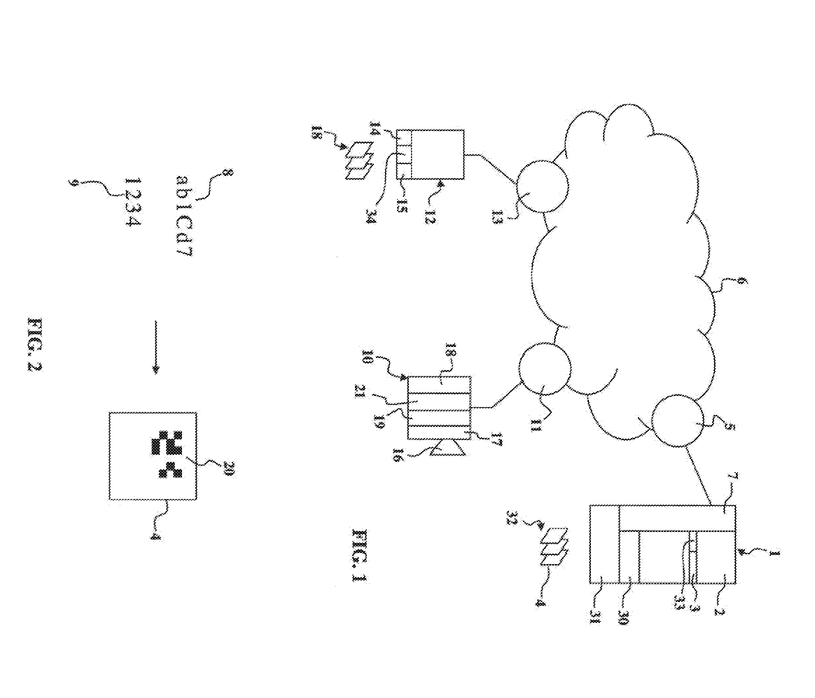

In the embodiment illustrated in FIG. 1, the reading and transmission computer terminal 10 furthermore comprises a local control means 17, able to check the customer password 9 entered by the customer on the input-output interface 19, compelling the customer to enter his password 9 correctly when he wishes to gain access to his personal account 3 in the database 2 of the commercial site 1. The local control means 17 may for example be developed with the aid of the Magento software.

In the case of a customer terminal 10 in the form of a mobile telephone of smartphone type, specific applications are recorded in the application memory of the mobile telephone, in order to provide the physical components of the mobile telephone with the functions of the previously described components of the reading and transmission computer terminal 10.

The reading means 16 are thus formed by the camera present in the mobile telephone 10, and the application program comprises program sequences for implementing the equivalent of the decryption means 21 and of the local control means 17. The keypad of the mobile telephone 10 forms the input-output interface 19. The communication circuit of the mobile telephone 10, enabling radio-wave communication, performs the function of the communication means 11.

In this embodiment with a mobile telephone 10, the customer is able to store, in his mobile telephone 10, the image 20 of his identification medium 4, which then forms a non-physical identification medium 4. When he wishes to access the commercial site 1, the specific application recorded in the mobile telephone 10 asks him to enter the customer password 9 and, if the check is satisfactory, the application encrypts the customer identifier 8 and the customer password 9 and sends them to the commercial site 1 via the Internet 6. After checking by the control means 7, the commercial site 1 provides access to the account 3 of the user in the database 2, and the customer is able to communicate using the keypad of his mobile telephone 10.

The commercial site 1 comprises means 30 for generating and managing the personal customer accounts 3 and for associating at least one identification medium 4 with each personal customer account 3. In practice, the commercial site 1 comprises issuing means 31 for issuing a supply 32 of identification media 4 which are then each able to be handed over to one of the customers desiring access.

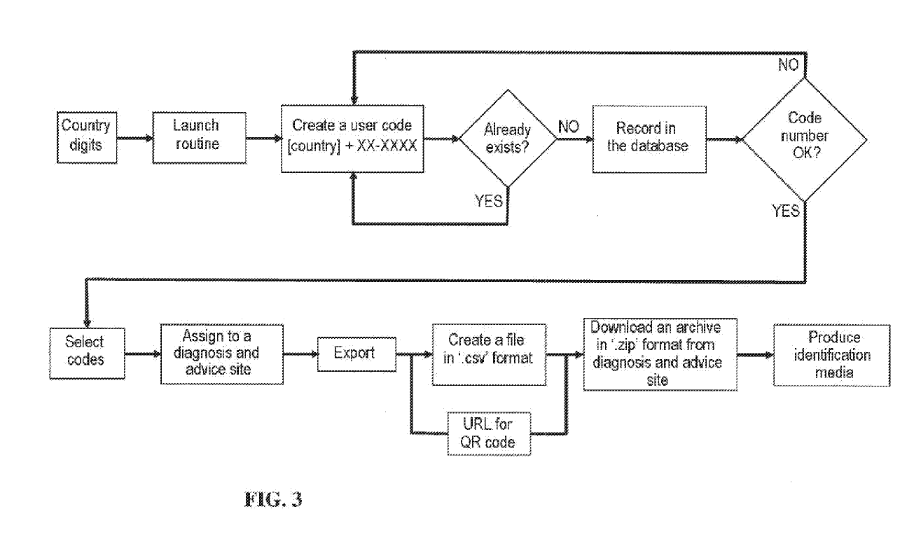

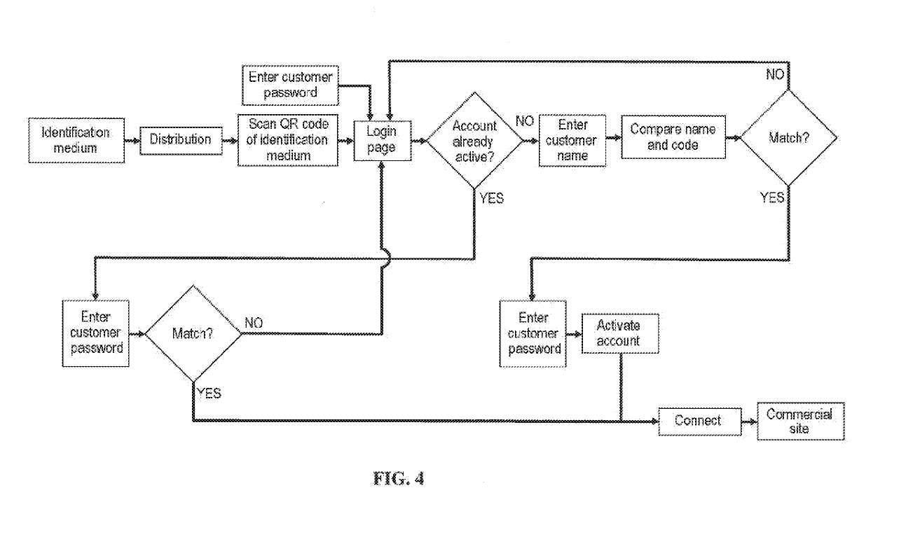

FIG. 3 is an example of a concise flow chart illustrating the steps of a computer sub-routine included in the issuing means 31.

The commercial site manages the payment for the products, and manages the delivery of the products purchased.

When first accessing the commercial site 1, the customer may have to fill in personal information requested from him. However, he does not have to remember any information other than his customer password 9, as simply possessing his identification medium 4 will guarantee him repeated and secure access to his personal customer account 3, which will become, from his first connection onwards, his personal account on the commercial site 1.

In the embodiments described previously, the identification medium 4 has been described as being a physical medium, for example in the form of a sheet of paper or a laminated card in bank card format.

As an alternative, it is possible to provide a non-physical identification medium 4, which is transmitted directly via the Internet 6 on the mobile telephone 10.

With consideration to FIG. 1, it is seen that the device for distributing products according to the invention furthermore comprises at least one diagnosis and advice site 12, having an input-output interface 34 that is able to be accessed by a consultant to whom the diagnosis and advice site 12 is assigned, which site also has an Internet connection means 13 for communicating with the commercial site 1 via the Internet 6.

The diagnosis and advice site 12 possesses its own consultant identifier 14 and its own consultant password 15. When the consultant requests access, he has to enter his consultant password 15 using the input-output interface 34, and the Internet 6 access control means 7 of the commercial site 1 perform a check on the consultant identifier 14 and a check on the consultant password 15.

The commercial site 1 transmits a supply 18 of the portable identification media 4 to the diagnosis and advice site 12. It is the consultant of the diagnosis and advice site 12 who assigns to each customer who requests one his respective identification medium 4 including the customer identifier 8, and who communicates to said customer his customer password 9.

When the customer password 9 is not present on the identification medium 4, it is the consultant who fills it in on the database of the commercial site 1, or who obtains it by interrogating the database of the commercial site 1.

The consultant of the diagnosis and advice site 12 possesses, by virtue of his consultant identifier 14 and of his consultant password 15, access rights that are broader than those of the customer on the commercial site 1. In this case, the diagnosis and advice site 12 has the rights to add products to the cart(s) 33 of the personal account 3 of the customer.

The customer, using his customer identifier 8 and his customer password 9, does not have the option of adding products that require a prescription from a consultant to his cart 33. He is able only to order all or some of the products listed in his cart 33 by the diagnosis and advice site 12, and he may possibly add additional products that do not require a prescription from a consultant.

The management of the respective rights of the customers, on the one hand, and those of the consultants of the diagnosis and advice site, on the other hand, is performed by the control means 7 of the commercial site 1. To this end, the computer program performing the check contains a routine comparing the instructions received from the consignor with a list of authorized instructions assigned to said consignor, and authorizing the transmission of only those instructions that are in accordance with said list of authorized instructions.

Using his customer identifier 8 and his customer password 9, the customer also has the option of modifying his customer password 9, by communicating the change to the commercial site 1 and possibly to his physical or non-physical identification medium 4.

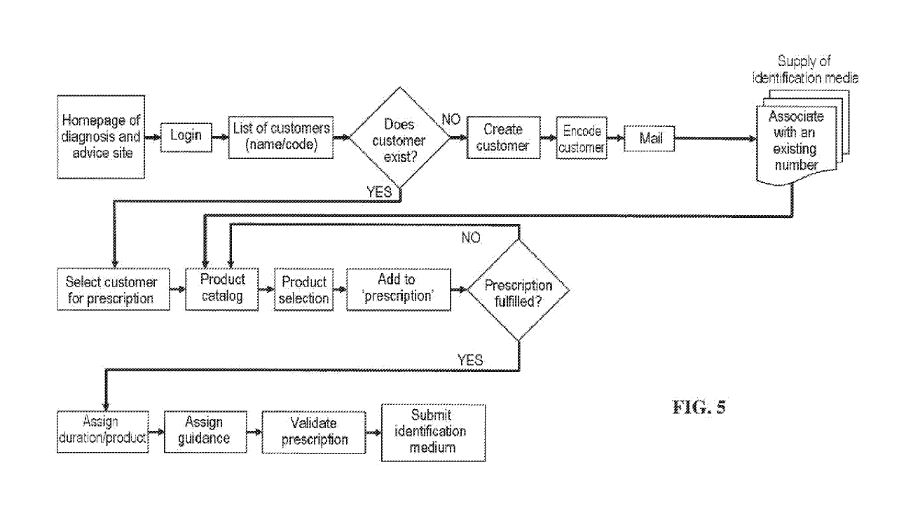

FIG. 4 illustrates the concise flow chart of a computer program routine implemented in the customer terminal 10 and performing a check on the identification medium 4 and the connection to the commercial site 1 via the Internet 6. This routine checks in particular whether the customer has already activated his personal customer account 3 by connecting to the commercial site 1 for a first time.

The Internet connection means 13 used by the diagnosis and advice site 12 may be a computer or a tablet. When a customer consults the diagnosis and advice site 12, the consultant establishes a diagnosis on the basis of the needs of the customer, and communicates, to the commercial site 1 via his computer or his tablet, the list of products that, in his opinion, meet the needs of the customer. Before communicating this list to the commercial site 1, the consultant delivers, to the customer, an identification medium 4 that the commercial site 1 has associated with a personal customer account 3 in its database 2 beforehand. The consultant may then communicate, to the commercial site 1, firstly the identity of the identification medium 4 that he has handed over to the customer, and secondly the list of products that he recommends to the customer. In this way, this list is added to the cart 33 of the personal account 3 of the customer. If necessary, the consultant fills in the customer password 9 in the database 2 of the commercial site 1, in agreement with the customer. FIG. 5 illustrates the concise flow chart of a computer program routine enabling this procedure to be implemented.

The customer is then free to decide whether or not he wishes to purchase the products listed in the cart 33 of his personal customer account 3. He is able to pay online.

When he decides, the customer actuates his reading and transmission terminal 10, enters his customer password 9 if necessary, and enters a list of desired products that he would like to be delivered, in order to transmit this information to the commercial site 1.

The commercial site 1 then compares the list of desired products and the list contained in the customer's cart 33, and authorizes delivery of the products present in both of the lists at the same time.

The commercial site 1 may communicate the information relating to the customer's purchases to the diagnosis and advice site 12.

The commercial site 1 may also send reminders to the customers when the customers are supposed to renew their purchases or when they have to consult the diagnosis and advice site 12 again.

The communications via the Internet 6 enable quick and reliable transmission of information between the customer, the diagnosis and advice site 12 and the commercial site 1.

The present invention is not limited to the embodiments that have been explicitly described, but it includes the numerous variants and generalizations thereof that are contained within the scope of the claims hereinafter.

1-16. (canceled)

17. A device for controlling the distribution of products, comprising:
a) a commercial site having:
a database,
preformatted personal customer accounts, each assigned to a corresponding portable identification medium containing a customer identifier,
a series of consultant identifiers and a corresponding series of consultant passwords,
means for accessing the database via the Internet,
Internet access control means that ensure, when a customer requests access, that a customer identifier and a customer password are checked,
b) at least one customer terminal, able to communicate with the commercial site via a secure Internet connection for payment operations,
c) at least one diagnosis and advice site, having an input-output interface able to be accessed by a consultant, having a connection means for communicating with the commercial site via an Internet connection, having its own consultant identifier, and having its own consultant password,
d) said Internet access control means furthermore ensuring, when a consultant requests access, that a consultant identifier and a consultant password are checked.

18. The device as claimed in claim 17, wherein the customer terminal comprises:
reading means for reading the data carried by a portable identification medium when the latter is presented by a customer, and for extracting the customer identifier therefrom,
entry means, by way of which the customer is able to enter his customer password,
communication means for communicating to the commercial site, via the Internet, the customer identifier and the customer password in order to gain access for the user to the preformatted personal customer account assigned to the portable identification medium presented by the customer.

19. The device as claimed in claim 18, wherein the customer terminal furthermore comprises local control means for compelling the customer to enter his customer password when he wishes to gain access to his personal customer account on the commercial site, and for checking the customer password entered by the customer.

20. The device as claimed in claim 17, wherein the commercial site comprises means for generating and managing personal customer accounts and for associating at least one identification medium with each personal customer account.

21. The device as claimed in claim 17, wherein the diagnosis and advice site has a supply of identification media, which its consultant is freely able to deliver to customers, and has rights, associated with its consultant identifier and its consultant password, to generate, on the commercial site, a cart in the account associated with the identification medium that the consultant delivers to a customer.

22. The device as claimed in claim 21, wherein a customer password is assigned beforehand, by the commercial site, to each customer identifier, and the diagnosis and advice site has rights, associated with its consultant identifier and its consultant password, to extract, from the commercial site, the customer password that the consultant is able to communicate to the customer.

23. The device as claimed in claim 21, wherein the diagnosis and advice site has rights, associated with its consultant identifier and its consultant password, to assign, to the identification medium, a customer password, in order to communicate it to the commercial site, which then associates it with the corresponding customer identifier, and the consultant communicates it to the customer.

24. The device as claimed in claim 21, wherein the customer, provided with his identification medium, has rights, associated with his customer identifier and his customer password, to order, on the commercial site, the products present in the cart generated by the consultant in the personal customer account associated with his identification medium.

25. The device as claimed in claim 17, wherein, in the identification medium, the customer identifier is encoded in an image able to be read optically, for example encoded in the form of a QR code.

26. The device as claimed in claim 25, wherein the customer password is also encoded in said image.

27. The device as claimed in claim 25, wherein the image is produced on a physical medium such as paper or a laminated card.

28. The device as claimed in claim 25, wherein the image is produced on a non-physical medium such as a digital recording.

29. A method for controlling the distribution of products from a commercial site, wherein:
the commercial site generates at least one identification medium in which a customer identifier is stored,
the commercial site assigns a personal customer account to the identification medium,
a diagnosis and advice site, run by a consultant, receives a supply of identification media from the commercial site, and the consultant of the diagnosis and advice site assigns, to each customer who requests one, one of the identification media from said supply of identification media,
the consultant of the diagnosis and advice site creates, on the commercial site, a cart in the personal customer account assigned to the identification medium handed over to the customer, into which cart said consultant places the list of products that may be suitable for the customer,
the consultant of the diagnosis and advice site extracts, from the commercial site, or assigns and communicates, to the commercial site, a customer password, and then communicates said customer password to the customer,
the customer connects to the commercial site via a customer terminal, by presenting his identification medium containing the customer identifier, and by entering his customer password, and he completes his personal customer account with his personal information, insofar as said information has not yet been recorded in his associated personal customer account,
the commercial site authorizes the delivery, to the customer, of the products listed in the cart created by the consultant of the diagnosis and advice site.

30. The method as claimed in claim 29, wherein:
in the identification medium, the customer identifier is encoded in the form of an image,
in the customer terminal, the customer presents his identification medium, the customer terminal reads the image from the identification medium in order to extract the customer identifier therefrom, and the customer enters his customer password,
the customer terminal sends, via the Internet, the customer identifier and the customer password to the commercial site, which performs a check in order to authorize the customer to communicate in order to place an order by way of the customer terminal.

31. The method as claimed in claim 30, wherein the image containing the customer identifier is an image of QR code type.

32. The method as claimed in claim 31, wherein the customer password is furthermore encoded in said image.
